(19) United States
(12) Patent Application Publication
(10) Pub. No.: US 2018/0354794 A1
(43) Pub. Date: Dec. 13, 2018

(54) REDUCTION OF THE NOX WASTE GAS CONCENTRATION IN THE PRODUCTION OF NITRIC ACID DURING A SHUTDOWN AND/OR START-UP PROCESS OF THE PRODUCTION DEVICE

(71) Applicants: THYSSENKRUPP INDUSTRIAL SOLUTIONS AG, Essen (DE); thyssenkrupp AG, Essen (DE)

(72) Inventor: Johannes DAMMEIER, Dortmund (DE)

(73) Assignees: THYSSENKRUPP INDUSTRIAL SOLUTIONS AG, Essen (DE); thyssenkrupp AG, Essen (DE)

(21) Appl. No.: 15/574,075

(22) PCT Filed: May 17, 2016
(86) PCT No.: PCT/EP2016/061029

§ 371 Date: Nov. 14, 2017

(30) Foreign Application Priority Data
May 20, 2015 (DE) 10 2015 209 243.7

(51) Int. Cl. C01B 21/40; B01J 19/24; B01J 10/00; B01J 19/00; C01B 21/28; C01B 21/26; B01D 53/86

(52) U.S. Cl. CPC C01B 21/40; B01D 2255/1023; B01J 10/002; B01J 19/0006; C01B 21/28; C01B 21/262; B01D 53/8628; B01J 2219/00164; B01D 2255/20738; B01D 2255/20753; B01D 2255/20761; B01D 2255/20746; B01D 2255/2073; B01D 2255/1025; B01D 2255/20723; B01D 2255/1021; B01D 2255/106; B01J 19/2445

(57) ABSTRACT

An apparatus and a process for reducing the concentration of NOx nitrogen oxides in residual gas may be employed during shutdown and/or startup of apparatuses for preparing nitric acid. An example apparatus for reducing NOx nitrogen oxides may include a reactor that produces NOx nitrogen oxides, an absorption apparatus that absorbs at least part of the NOx nitrogen oxides produced in an aqueous composition, a residual gas purification plant that decomposes and/or reduces unabsorbed NOx nitrogen oxides, feed means for feeding the NOx nitrogen oxides to the absorption apparatus, discharge means for discharging the unabsorbed NOx nitrogen oxides from the absorption apparatus to the residual gas purification plant, and a bypass that transfers a gas mixture from the reactor to the residual gas purification plant while bypassing the absorption apparatus during startup and/or shutdown of the apparatus for preparing nitric acid.

The invention relates to an apparatus and a process for reducing the concentration of NOₓ nitrogen oxides in residual gas which is obtained during shutdown and/or start-up of apparatuses for preparing nitric acid.

To prepare nitric acid, NH₃ is usually catalytically oxidized by means of atmospheric oxygen. This forms NO, which is oxidized by means of O₂ to NO₂ and subsequently absorbed in H₂O in an absorption apparatus to form HNO₃. NO and NO₂ are referred to as nitrous gases or else as NOₓ nitrogen oxides. Modern plants for preparing nitric acid are operated under superatmospheric pressure in order to achieve higher acid concentrations and better efficiencies in the absorption and higher degrees of removal of NOₓ nitrogen oxides in the residual gas.

A distinction is made between two-pressure and monopressure plants. In the case of two-pressure plants, the production of the NOₓ nitrogen oxides occurs by oxidation of ammonia at a pressure of from about 4·10⁵ to 6·10⁵ Pa (4 to 6 bar) and the absorption of the NOₓ nitrogen oxides produced in this way in water to form nitric acid occurs at from 1·10⁶ to 1.5·10⁶ Pa (10 to 15 bar). In the case of monopressure plants, on the other hand, the gas production and the absorption are carried out at approximately the same pressure of from about 6·10⁵ to 1.4·10⁶ Pa (6 to 14 bar). Compressors which are driven by means of a gas and/or steam turbine or electric motor serve to generate the pressure.

Modern plants for preparing nitric acid are equipped with residual gas purification plants in order to reduce the concentration of the NOₓ nitrogen oxides in the residual gas. The residual gas having a reduced concentration of NOₓ nitrogen oxides is subsequently released as offgas into the environment. Here, the NOₓ nitrogen oxides, i.e. NO and NO₂, are usually reduced in the residual gas purification plants by SCR (selective catalytic reduction) processes with introduction of suitable reducing agents, e.g. ammonia, over suitable SCR catalysts, e.g. V₂O₅/TiO₂-based DeNOx catalysts. The relative proportion of NO₂ based on the total molar amount of NOₓ in the residual gas is characterized by the degree of oxidation of the NOₓ. A further development of the SCR technology in the field of nitric acid technology is the EnviNOx® process in which NOₓ nitrogen oxides are reduced particularly effectively by introduction of suitable reducing agents and NOₓ is in many cases virtually no longer detectable in the offgas. In addition, N₂O is likewise reduced or catalytically decomposed.

According to regulations imposed by the authorities, the concentrations of the NOₓ nitrogen oxide emissions must not exceed a maximum limit value. At present, a value of 50 ppm is a customary limit value, but it is to be expected that this will be reduced in the future.

However, in contrast to steady-state operation of the plants for preparing nitric acid, it is at present not possible, or possible to only limited extent, to avoid emissions of NOₓ nitrogen oxides which significantly exceed the limit values for limited periods of time during shutdown and/or start-up or in the case of the plant going down.

In the case of going down or during shutdown of the plant for preparing nitric acid, the NOₓ nitrogen oxides present under pressure in the plant are usually depressurized via the absorption apparatus and the residual gas purification plant into the environment. However, the residual gas purification plant can be kept in operation only down to a particular permissible limit temperature below which it has to be taken out of operation. This is because residual gas purification systems in which NH₃ is used as reducing agent for the NOₓ nitrogen oxides can be operated in the long term only above a minimum limit temperature in order to avoid undesirable formation and accumulation of NH₄NO₃ on the SCR catalyst. This limit temperature is frequently in the range from 170 to 200° C. In steady-state operation, plants for preparing nitric acid typically attain operating temperatures of from about 300° C. to about 600° C., with the residual gas purification plant being able to be operated without undesirable formation and accumulation of NH₄NO₃.

In general, the switching-off of the residual gas purification plant has to be carried out before complete depressurization of the plant, for which reason the concentration of the NOₓ nitrogen oxides in the residual gas to be released into the environment increases greatly. A further increase in the NOₓ nitrogen oxide emissions arises because the absorption apparatus which is usually equipped with sieve trays becomes unstable with increasing depressurization of the plant, so that the absorption efficiency drops greatly. As soon as the residual gas purification plant is out of operation, the concentration of NOₓ nitrogen oxide emissions will increase greatly during further depressurization.

In the case of going down or shutdown of a plant for preparing nitric acid, the introduction of ammonia for gas production is usually firstly shut off before the machinery of the plant is switched off. As long as the residual gas purification plant can be kept in operation with adherence to the limit temperatures, the residual gas to be released into the environment will not exceed the concentration of NOₓ nitrogen oxides and the residual gas will be colorless. It is advantageous here to keep the machinery in operation as long as possible until the NOₓ nitrogen oxides in the plant for preparing nitric acid have been replaced by air. However, when it is necessary to switch off the machinery immediately or shortly after shutting off the supply of ammonia, such gas replacement is no longer ensured. Significantly higher emissions of NOₓ nitrogen oxides occur during further depressurization and the resulting inevitable attainment of the limit temperature for the residual gas purification plant and the resulting going down of the residual gas purification plant.

Owing to the thermodynamic equilibrium, the NOₓ nitrogen oxides are predominantly in the form of NO₂ as the operating temperature cools, for which reason these become visible as brown gas in the residual gas which is released into the environment.

During start-up of the plant, too, the limit value of the concentration of NOₓ nitrogen oxides in the residual gas released into the environment is exceeded. Part of this residual gas is made up of gases which have remained in the pipes and apparatuses, or have been formed therein, during stoppage of the plant. The absorption of NOₓ nitrogen oxides in an aqueous composition is a reversible process which is in equilibrium with the desorption of NOₓ nitrogen oxides from the aqueous composition. For this reason, a further part of the NOₓ nitrogen oxides results from outgassing of NOₓ from nitric acid with which the absorption apparatus is usually filled during restarting of the plant.

In order to reduce the concentration of NOₓ nitrogen oxides in the residual gas from a plant for preparing nitric acid, the residual gas purification plant is taken into operation as soon as possible during start-up of the plant. The residual gas is usually released into the environment via an expander after flowing through the residual gas purification plant, resulting in the residual gas cooling down. As long as the residual gas has not yet attained a sufficiently high operating temperature, the residual gas purification cannot be taken into operation since there is a risk of formation and deposition of combustible and explosive ammonium nitrate and ammonium nitrite from NH₃ and NOₓ nitrogen oxides. For this reason, a reduction in the NOₓ nitrogen oxides in the residual gas from a plant for preparing nitric acid is desirable.

DE 10 2012 000 569 A1 discloses a process for the colorless start-up and shutdown of nitric acid plants. During start-up and/or shutdown of the nitric acid plant, a pressurized heated fluid is fed into the nitric acid plant in order to reduce the speed of the temperature decrease of the gas flowing through the nitric acid plant during shutdown of the plant or in order to increase the speed of the temperature rise of the gas flowing through the nitric acid plant during start-up of the plant.

DE 10 2012 010 017 A1 discloses a process for reducing the nitrogen oxide offgas concentration in a nitric acid plant during shutdown and/or start-up and also nitric acid plants suitable for this. The process is characterized in that pressurized offgas containing nitrogen oxides from the nitric acid plant and also gaseous reducing agent for the nitrogen oxides are fed into a catalyst-filled reactor, which is provided in addition to the reactor for residual gas purification, during start-up and/or shutdown of the nitric acid plant.

However, the processes and the apparatuses of a plant operated under pressure for preparing nitric acid are not satisfactory in every respect during shutdown and/or start-up of the plant and there is a need for improved processes and apparatuses.

It is an object of the invention to reduce the concentration of NOₓ nitrogen oxides in the residual gas which is obtained during shutdown and/or start-up of apparatuses for preparing nitric acid and is released into the environment.

This object is achieved by the subject matter of the claims.

A first aspect of the invention relates to an apparatus for preparing nitric acid from NOₓ nitrogen oxides comprising the actively interconnected components:
(i) a reactor configured for producing NOₓ nitrogen oxides;
(ii) an absorption apparatus configured for absorption of at least part of the NOₓ nitrogen oxides produced in an aqueous composition;
(iii) a residual gas purification plant configured for decomposing and/or reducing unabsorbed NOₓ nitrogen oxides;
(iv) feed means configured for feeding the NOₓ nitrogen oxides produced from the reactor to the absorption apparatus;
(v) discharge means configured for discharging unabsorbed NOₓ nitrogen oxides from the absorption apparatus to the residual gas purification plant; and
(vi) a bypass configured for transferring a gas mixture from the reactor to the residual gas purification plant with bypassing of the absorption apparatus during start-up and/or shutdown of the apparatus for preparing nitric acid.

The apparatus of the invention comprises a reactor which is configured for producing NOₓ nitrogen oxides. The reactor is preferably configured for reacting NH₃ to produce NOₓ nitrogen oxides. Suitable reactors are known to those skilled in the art.

The apparatus of the invention comprises an absorption apparatus which is configured for absorption of at least part of the NOₓ nitrogen oxides produced in an aqueous composition. Suitable absorption apparatuses, for example absorption towers, are known to those skilled in the art. To prepare nitric acid, the NOₓ nitrogen oxides produced in the reactor are preferably passed through the absorption apparatus. The absorption apparatus is preferably configured for absorbing at least 10% by volume of the NOₓ nitrogen oxides produced in the reactor, preferably at least 20% by volume, at least 30% by volume, at least 40% by volume, at least 50% by volume, at least 60% by volume, at least 70% by volume, at least 80% by volume, at least 90% by volume or at least 99% by volume. The absorption apparatus preferably comprises sieve trays or bubble cap trays. The sieve trays or the bubble cap trays are preferably configured for accommodating the aqueous composition which absorbs the NOₓ nitrogen oxides. The sieve trays are preferably configured for accommodating the aqueous composition as soon as the residual gas purification plant has been taken into operation during start-up of the apparatus for preparing nitric acid. The aqueous composition preferably comprises nitric acid. The bubble cap trays are preferably configured for having already been filled with the aqueous composition when the apparatus for preparing nitric acid is started up.

The absorption apparatus is preferably configured in such a way that the NOₓ nitrogen oxides flow into the absorption apparatus at the bottom end, flow from the bottom upward through the absorption apparatus and leave the absorption apparatus at the upper end. The absorption apparatus is preferably configured for cooling the NOₓ nitrogen oxides. The cooling of the NOₓ nitrogen oxides in the absorption apparatus preferably occurs in that the NOₓ nitrogen oxides are cooled by at least 10° C., preferably by at least 20° C., at least 30° C., at least 40° C., at least 50° C., at least 60° C., at least 70° C., at least 80° C., at least 90° C. or at least 100° C., while flowing through the absorption apparatus.

The absorption apparatus is preferably configured so that its volume, based on the total volume of all parts of the apparatus for preparing nitric acid, is at least 10% by volume, more preferably at least 20% by volume, at least 30% by volume, at least 40% by volume, at least 50% by volume, at least 60% by volume, at least 70% by volume, at least 80% by volume, at least 90% by volume or at least 99% by volume.

The residual gas purification plant is configured for decomposing and/or reducing unabsorbed NOₓ nitrogen oxides. Residual gas purification plants are known to those skilled in the art and make it possible to reduce the NOₓ nitrogen oxides NO and NO₂, usually by means of SCR processes with introduction of suitable reducing agents. In addition, they preferably allow catalytic reduction or decomposition of N₂O. The residual gas purification plant is preferably provided with catalysts for removing NOₓ nitrogen oxides (DeNOₓ catalysts). These catalysts are known to those skilled in the art.

The catalysts are generally transition metal catalysts which promote the reduction of NOₓ nitrogen oxides by means of reducing agents. Preference is given to classical DeNOₓ catalysts, in particular those which contain transition metals and/or transition metal oxides, e.g. iron oxides, nickel oxides, copper oxides, cobalt oxides, manganese oxides, rhodium oxides, rhenium oxides or vanadium oxides or metallic platinum, gold or palladium or else mixtures of two or more of these compounds. Particular preference is given to catalysts based on V₂O₅—TiO₂.

Apart from the DeNOₓ catalysts which catalyze the reduction of NOₓ nitrogen oxides by means of reducing agents, the residual gas purification plant can additionally contain catalysts which promote the chemical decomposition of N₂O into nitrogen and oxygen or the chemical reduction of N₂O by means of reducing agents. These catalysts are known to those skilled in the art.

Reducing agents for nitrogen oxides, in particular reducing agents for NOₓ nitrogen oxides, are introduced in addition to the residual gas containing NOₓ nitrogen oxides into the residual gas purification plant. Suitable reducing agents for NOₓ nitrogen oxides are, for example, nitrogen-containing reducing agents. Particular preference is given to using ammonia as reducing agent for nitrogen oxides, in particular for NOₓ nitrogen oxides. The required amounts of reducing agent are dependent on the type of reducing agent and can be determined by a person skilled in the art by means of routine experiments.

The residual gas purification plant is preferably configured for reducing the concentration of NOₓ nitrogen oxides in the residual gas from the apparatus for preparing nitric acid by at least 10%, more preferably by at least 20%, at least 30%, at least 40%, at least 50%, at least 60%, at least 70%, at least 80%, at least 90% or at least 99%.

The apparatus for preparing nitric acid from NOₓ nitrogen oxides further comprises feed means which are configured for feeding the NOₓ nitrogen oxides produced from the reactor to the absorption apparatus, and discharge means which are configured for discharging unabsorbed or desorbed NOₓ nitrogen oxides from the absorption apparatus to the residual gas purification plant. Here, the feed means and discharge means preferably comprise suitable pipes by means of which the reactor, the absorption apparatus and the residual gas purification plant are connected to one another in a way which ensures the general functionality of the apparatus. The measures required for this are known to those skilled in the art.

The feed means are preferably configured in such a way that the NOₓ nitrogen oxides produced by the reactor are fed into the absorption apparatus at the lower end. The discharge means are preferably configured in such a way that the unabsorbed or desorbed NOₓ nitrogen oxides are discharged from the upper end of the absorption apparatus to the residual gas purification plant.

The apparatus for preparing nitric acid comprises a bypass which is configured for transferring a gas mixture from the reactor to the residual gas purification plant with bypassing of the absorption apparatus during start-up and/or shutdown of the apparatus for preparing nitric acid.

A person skilled in the art can distinguish the state of an apparatus for preparing nitric acid during start-up and/or shutdown thereof from the state of the apparatus during steady-state operation thereof. The start-up of the apparatus precedes steady-state operation; the shutdown of the apparatus follows steady-state operation.

The gas mixture which is transferred from the reactor to the residual gas purification plant with bypassing of the absorption apparatus during start-up and/or shutdown of the apparatus for preparing nitric acid preferably comprises air. The gas mixture can optionally comprise further constituents. The gas mixture preferably comprises air and NOₓ nitrogen oxides. The gas mixture is preferably conveyed through the bypass before ignition or after stopping of the combustion of ammonia during start-up and/or shutdown of the apparatus for preparing nitric acid from the gas mixture. The bypass is preferably arranged between the feed means and the discharge means. The bypass preferably comprises a pipe which is actively connected to the feed means and the discharge means of the apparatus of the invention.

The gas mixture which is transferred from the reactor to the residual gas purification plant with bypassing of the absorption apparatus is preferably heated. The gas mixture is preferably heated during shutdown and/or start-up of the apparatus for preparing nitric acid. The gas mixture is preferably heated before ignition or after stopping of the combustion of ammonia during start-up and/or shutdown of the apparatus for preparing nitric acid. The gas mixture is preferably heated to such a temperature that the residual gas purification plant can be kept in operation for as long as possible during shutdown of the apparatus for preparing nitric acid or can be taken into operation as early as possible during start-up of the apparatus for preparing nitric acid.

The gas mixture is preferably heated to a temperature of at least 100° C., more preferably at least 150° C., at least 200° C., at least 250° C., at least 300° C., at least 350° C., at least 400° C., at least 450° C., at least 500° C., at least 550° C. or at least 600° C., during shutdown and/or start-up of the apparatus for preparing nitric acid.

The gas mixture can be heated by means of all apparatuses and processes known to an inventor. For example, the gas mixture can be heated by means of a burner, by means of steam, by means of heat of compression or by means of an electrical device.

The gas mixture which is transferred from the reactor to the residual gas purification plant with bypassing of the absorption apparatus during start-up and/or shutdown of the apparatus for preparing nitric acid is preferably compressed in a compression apparatus. The compression apparatus is preferably configured for compressing a gas mixture. According to the invention, all apparatuses suitable for compressing a gas mixture can be used. An air compressor is preferably used for compressing a gas mixture. For example, it is possible to use turbocompressors as air compressors.

In a preferred embodiment, the apparatus of the invention comprises further actively interconnected components. The apparatus preferably comprises at least a first heat exchanger which is arranged preferably downstream of the reactor and preferably upstream of the absorption apparatus and which is preferably configured for cooling the NOₓ nitrogen oxides which are fed via the feed means from the reactor to the absorption apparatus.

The apparatus of the invention preferably comprises one or more further heat exchangers which are arranged preferably downstream of the absorption apparatus and preferably upstream of the residual gas purification plant and are preferably configured for heating the NOₓ nitrogen oxides which are transferred via the discharge means from the absorption apparatus to the residual gas purification plant and/or are transferred via the bypass from the reactor to the residual gas purification plant. The NOₓ nitrogen oxides are preferably heated by at least 20° C., more preferably by at least 40° C., at least 60° C., at least 80° C., at least 100° C., at least 120° C., at least 140° C., at least 160° C., at least 180° C., at least 200° C., at least 220° C., at least 240° C., at least 260° C., at least 280° C., at least 300° C., at least 320° C., at least 340° C., at least 360° C., at least 380° C., at least 400° C., at least 420° C., at least 440° C. or at least 450° C., in the residual gas heater.

The heat exchangers according to the invention are, according to the invention, not restricted in terms of their structure. Suitable heat exchangers encompass shell-and-tube heat exchangers, plate heat exchangers, helical heat exchangers, U-tube heat exchangers, sheet-and-tube heat exchangers, etc.

The apparatus of the invention preferably comprises a mixing device which is arranged preferably downstream of the residual gas heater and preferably upstream of the residual gas purification plant. The mixing device is preferably configured for mixing the unabsorbed or desorbed NOₓ nitrogen oxides which are fed to the residual gas purification plant via the discharge means and/or the bypass with, preferably, ammonia.

In a preferred embodiment, the apparatus comprises a control device which is configured
for opening and closing the bypass; and/or
for opening and closing the feed means; and/or
for opening and closing the discharge means.

The control device is preferably arranged downstream of the reactor and upstream of the absorption apparatus.

The control device is preferably configured for opening and closing the bypass and for opening and closing the feed means. The control device is preferably configured in such a way that the feed means are closed when opening the bypass. The control device is preferably configured in such a way that the feed means are opened when closing the bypass. The control device is preferably configured in such a way that opening of the bypass causes closing of the feed means. The control device is preferably configured in such a way that closing of the bypass causes opening of the feed means. The opening or closing of the bypass and the opening or closing of the feed means preferably occur simultaneously.

The control device preferably comprises closure devices for opening or closing a pipe, which preferably comprise at least one valve. The closure devices of the control device for opening or closing the pipes can be arranged at one position or at various positions. If the closure devices are installed at one position, the control device is preferably arranged at the place where the bypass branches off from the feed means. On the other hand, if the closure devices are arranged at various positions, preference is given to at least one closure device being arranged on the bypass and at least one closure device being arranged on the feed means.

The control device is preferably configured in such a way that the opening or closing of the bypass and the opening or closing of the feed means occur as a function of the operation of the apparatus for preparing nitric acid. During shutdown and/or start-up of the apparatus for preparing nitric acid, preference is given to the feed means being closed and the bypass being opened. In steady-state operation of the apparatus for preparing nitric acid, preference is given to the bypass being closed and the feed means being opened.

A person skilled in the art can distinguish the state of an apparatus for preparing nitric acid during shutdown and/or start-up thereof from the state of the apparatus during steady-state operation thereof. The shutdown of the apparatus follows steady-state operation, while start-up of the apparatus precedes steady-state operation.

In another preferred embodiment, the control device is configured in such a way that the opening or closing of the bypass and/or the opening or closing of the feed means occurs as a function of the operation of the residual gas purification plant. The control device is preferably configured in such a way that it brings about closing of the bypass and opening of the feed means during operation of the residual gas purification plant.

The control device preferably brings about opening of the bypass and closing of the feed means as soon as or as long as the residual gas purification plant is not in operation.

In a preferred embodiment, the control device is additionally or alternatively configured for opening and closing the discharge means.

The control device is preferably configured for opening and closing the bypass and for opening and closing the feed means and for opening and closing the discharge means.

If the control device is additionally or alternatively configured for opening and closing the discharge means, the control device preferably comprises a closure device which is arranged downstream of the absorption apparatus, preferably at the outlet of the absorption apparatus. The closure device preferably comprises a valve which is configured for opening and closing the discharge means. The control device is preferably configured for the simultaneous opening and closing of the feed means and discharge means, so that the control device simultaneously opens or closes the feed means and the discharge means.

The control device is preferably configured in such a way that the feed means and discharge means are closed on opening of the bypass. The control device is preferably configured in such a way that the feed means and discharge means are opened when the bypass is closed. The control device is preferably configured in such a way that the opening of the bypass causes closing of the feed means and the discharge means. The control device is preferably configured in such a way that the closing of the bypass causes the opening of the feed means and the discharge means. The opening or closing of the bypass and the opening or closing of the feed means and of the discharge means preferably occur simultaneously.

The control device is preferably configured in such a way that the opening or closing of the discharge means occurs as a function of the operation of the apparatus for preparing nitric acid. The discharge means are preferably closed during shutdown and/or start-up of the apparatus for preparing nitric acid. The discharge means are preferably opened in steady-state operation of the apparatus for preparing nitric acid.

In another preferred embodiment, the control device is configured in such a way that the opening or closing of the discharge means occurs as a function of the operation of the residual gas purification plant. The control device is preferably configured in such a way that it brings about opening of the discharge means during operation of the residual gas purification plant. The control device preferably brings about closing of the discharge means as soon as or as long as the residual gas purification plant is not in operation.

In another preferred embodiment, the opening or closing of the bypass occurs without closing of the feed and discharge means. The pressure drop in the absorption apparatus is preferably sufficiently high that the greater part of the gas mixture which flows through the apparatus for preparing nitric acid flows through the bypass.

The control device for blocking-in of the NOₓ nitrogen oxides in the absorption apparatus is preferably configured in such a way that the NOₓ nitrogen oxides cannot get out of the absorption apparatus. Closing of the discharge means and of the feed means preferably occurs during shutdown of the apparatus for preparing nitric acid and as soon as the residual gas purification plant is not in operation. The opening of the feed means and discharge means during start-up of the apparatus for preparing nitric acid preferably occurs as soon as the residual gas purification plant is in operation.

The absorption apparatus is preferably configured in such a way that at least 10% by volume of the NOₓ nitrogen oxides, based on the total volume of all apparatus parts of the apparatus for preparing nitric acid, can be blocked-in in the absorption apparatus, more preferably at least 20% by volume, at least 30% by volume, at least 40% by volume, at least 50% by volume, at least 60% by volume, at least 70% by volume, at least 80% by volume or at least 90% by volume.

In a preferred embodiment, the bypass is configured for transferring the gas mixture from the reactor to the residual gas purification plant with bypassing of the absorption apparatus and bypassing at least one heat exchanger. The bypass is preferably for transferring the NOₓ nitrogen oxides produced from the reactor to the residual gas purification plant with bypassing of the absorption apparatus and with bypassing of the heat exchanger which is arranged downstream of the reactor and upstream of the absorption apparatus and is configured for cooling the NOₓ nitrogen oxides. The opening of the bypass and the closing of the feed means during shutdown of the apparatus for preparing nitric acid preferably occurs after stopping of the combustion of NH₃ in the reactor, so that the NOₓ nitrogen oxides present downstream of the reactor are conveyed to the residual gas purification plant and can there be decomposed or reduced with utilization of their residual heat.

A further aspect of the invention comprises a process for reducing the concentration of NOₓ nitrogen oxides in residual gas which is obtained during shutdown and/or start-up of the apparatus of the invention for preparing nitric acid, wherein the process comprises the following steps:
(a) stopping of the feeding of a gas mixture from the reactor to the absorption apparatus; and
(b) transferring of the gas mixture from the reactor to the residual gas purification plant with bypassing of the absorption apparatus.

All preferred embodiments which are described above in connection with the apparatus of the invention apply correspondingly and analogously to the process of the invention as well.

The gas mixture preferably comprises air. In another preferred embodiment, the gas mixture comprises air and NOₓ nitrogen oxides. The gas mixture can optionally comprise further constituents which are inert in the process of the invention.

The stopping of the feeding of the gas mixture from the reactor to the absorption apparatus preferably occurs as a function of the operation of the apparatus for preparing nitric acid. The introduction of the gas mixture into the absorption apparatus in step (a) is preferably stopped exclusively on shutdown and/or start-up but not in steady-state operation of the apparatus for preparing nitric acid.

In step (b) of the process of the invention, the gas mixture is transferred from the reactor to the residual gas purification plant with bypassing of the absorption apparatus to the residual gas purification plant. The gas mixture is preferably transferred from the reactor to the residual gas purification plant with bypassing of the absorption apparatus as a function of the operation of the apparatus for preparing nitric acid. The gas mixture is preferably transferred to the residual gas purification plant with bypassing of the absorption apparatus in step (b) during shutdown and/or start-up of the apparatus for preparing nitric acid. The gas mixture is preferably transferred to the residual gas purification plant with bypassing of the absorption apparatus before ignition or after stopping of the combustion of ammonia during shutdown and/or start-up of the apparatus for preparing nitric acid.

The steps (a) and (b) according to the invention preferably occur simultaneously.

In a preferred embodiment, the transfer of the gas mixture from the reactor to the residual gas purification plant in step (b) occurs with bypassing of the absorption apparatus and with bypassing of a heat exchanger. The transfer of the gas mixture from the reactor to the residual gas purification plant with bypassing of the absorption apparatus and bypassing a heat exchanger preferably occurs before ignition or after stopping of the combustion of ammonia during shutdown and/or start-up of the apparatus for preparing nitric acid. The transfer of the gas mixture from the reactor to the residual gas purification plant in step (b) preferably occurs with bypassing of the absorption apparatus and with bypassing of the heat exchanger which is arranged downstream of the reactor and upstream of the absorption apparatus and is configured for cooling the gas mixture and heating the residual gas. On shutting down the apparatus for preparing nitric acid, preference is given to opening the bypass and closing the feed means after stopping of the combustion of NH₃ in the reactor so that the NOₓ nitrogen oxides present downstream of the reactor are conveyed to the residual gas purification plant and can be decomposed or reduced there with utilization of their residual heat.

The transfer of the gas mixture from the reactor to the residual gas purification plant in step (b) preferably occurs with bypassing of the absorption apparatus, with bypassing of a heat exchanger and with bypassing of at least one further apparatus part of the apparatus for preparing nitric acid. The further apparatus part preferably comprises a part of the apparatus for preparing nitric acid in which nitric acid can accumulate during the process of the invention. The further apparatus part which is bypassed in step (b) preferably comprises at least one further heat exchanger.

In a preferred embodiment, the process comprises the additional step
(c) stopping of the discharge of unabsorbed NOₓ nitrogen oxides or desorbed NOₓ nitrogen oxides from the absorption apparatus to the residual gas purification plant.

The discharge of unabsorbed NOₓ nitrogen oxides or desorbed NOₓ nitrogen oxides from the absorption apparatus to the residual gas purification plant is preferably stopped as a function of the operation of the apparatus for preparing nitric acid. The discharge in step (c) is preferably stopped during shutdown and/or start-up of the apparatus for preparing nitric acid. Steps (a) and (c) of the process of the invention preferably occur simultaneously. Preference is given to the steps (a), (b) and (c) of the process of the invention occurring simultaneously.

In a preferred embodiment, step (a) and/or step (b) and/or step (c) are carried out as soon as the residual gas purification plant is taken out of operation during shutdown of the apparatus for preparing nitric acid or as long as the residual gas purification plant is not yet in operation during start-up of the apparatus for preparing nitric acid.

In step (a), the feeding of the gas mixture from the reactor to the absorption apparatus is preferably stopped as soon as the residual gas purification plant is taken out of operation during shutdown of the apparatus for preparing nitric acid or as long as the residual gas purification plant is not yet in operation during start-up of the apparatus for preparing nitric acid.

In step (b), the gas mixture is preferably transferred from the reactor to the residual gas purification plant with bypassing of the absorption apparatus as soon as the residual gas purification plant is taken out of operation during shutdown of the apparatus for preparing nitric acid or as long as the residual gas purification plant is not yet in operation during start-up of the apparatus for preparing nitric acid.

In step (c), the discharge of unabsorbed NOₓ nitrogen oxides or desorbed NOₓ nitrogen oxides from the absorption apparatus to the residual gas purification plant is preferably stopped as soon as the residual gas purification plant is taken out of operation during shutdown of the apparatus for preparing nitric acid or as long as the residual gas purification plant is not yet in operation during start-up of the apparatus for preparing nitric acid.

In a preferred embodiment, the bypassing of the absorption apparatus in step (b) is stopped as long as the residual gas purification plant is in operation during shutdown of the apparatus for preparing nitric acid or as soon as the residual gas purification plant is taken into operation during start-up of the apparatus for preparing nitric acid.

In a preferred embodiment, at least part of the NOₓ nitrogen oxides which are present within the apparatus for preparing nitric acid are blocked-in in the absorption apparatus by the stopping of the feeding of the gas mixture from the reactor to the absorption apparatus in step (a).

In a preferred embodiment, the blocking-in of the NOₓ nitrogen oxides in the absorption apparatus occurs in addition by the stopping of the discharge of unabsorbed or desorbed NOₓ nitrogen oxides from the absorption apparatus to the residual gas purification plant in step (c).

During shutdown and/or start-up of the apparatus for preparing nitric acid, preference is given to at least 10% by volume of the NOₓ nitrogen oxides present in the apparatus for preparing nitric acid being blocked-in in the absorption apparatus, more preferably at least 20% by volume, at least 30% by volume, at least 40% by volume, at least 50% by volume, at least 60% by volume, at least 70% by volume, at least 80% by volume or at least 90% by volume, in each case based on the total volume of all apparatus parts of the apparatus for preparing nitric acid.

The absorption apparatus of the process of the invention preferably comprises sieve trays which are filled with nitric acid on start-up of the apparatus for preparing nitric acid, with the filling with nitric acid being carried out as soon as the residual gas purification plant has been taken into operation.

In another preferred embodiment, the absorption apparatus comprises bubble cap trays which have already been filled with nitric acid on start-up of the apparatus for preparing nitric acid.

In a preferred embodiment, at least part of the nitric acid which condenses out in a heat exchanger is conveyed into the absorption apparatus. Preference is given to at least 10% by volume of the nitric acid which condenses out in a heat exchanger being conveyed into the absorption apparatus, more preferably at least 20% by volume, at least 30% by volume, at least 40% by volume, at least 50% by volume, at least 60% by volume, at least 70% by volume, at least 80% by volume or at least 90% by volume, in each case based on the total amount of nitric acid condensed out in a heat exchanger. The nitric acid condensed out in a heat exchanger is preferably conveyed in its entirety into the absorption apparatus.

In a preferred embodiment, the apparatus of the invention is used in the process of the invention.

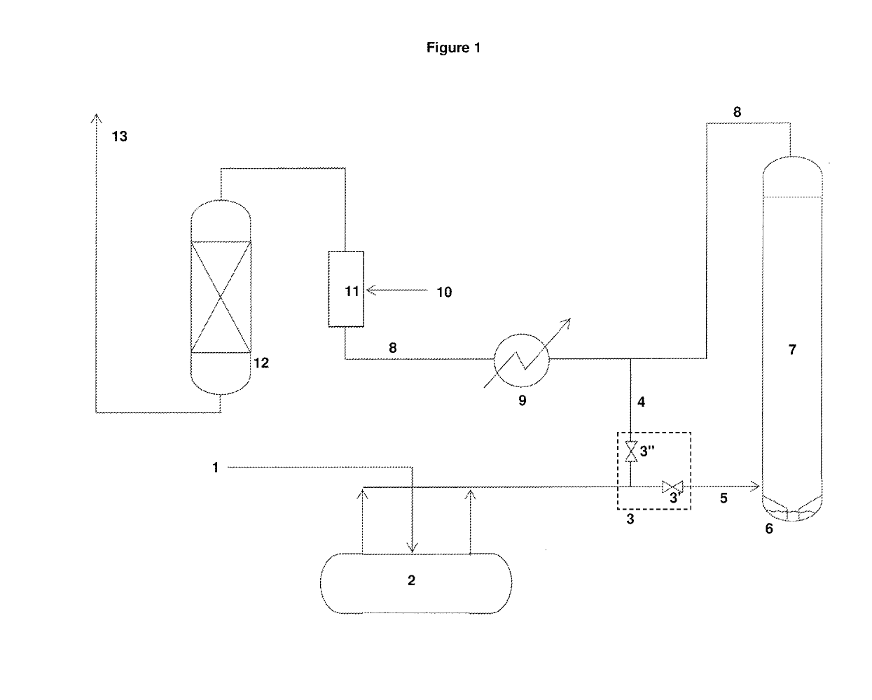

The apparatus of the invention for preparing nitric acid from NOₓ nitrogen oxides is illustrated schematically and by way of example in FIG. 1, but the FIGURE should not be construed as constituting a restriction. Here, as is customary in nitric acid production, NOₓ nitrogen oxides (1) are preferably produced in a reactor which is preferably supplied with ammonia and air.

In the preparation of nitric acid in steady-state operation, these NOₓ nitrogen oxides (1) are fed, preferably via one or more heat exchangers (2) and preferably via the feed means (5), to the absorption apparatus (7), with at least part of the NOₓ nitrogen oxides being absorbed by an aqueous composition to form nitric acid which preferably accumulates in the bottom region (6) of the absorption apparatus. Unabsorbed or desorbed NOₓ nitrogen oxides are preferably conveyed via discharge means (8) to a mixing device (11) in which the NOₓ nitrogen oxides are preferably mixed with ammonia (10). They can optionally firstly be fed to a further heat exchanger (9) for this purpose. The NOₓ nitrogen oxides which are preferably mixed with ammonia are then preferably fed to the residual gas purification plant (12) and the excess residual gas (13) is preferably released into the environment.

During shutdown and/or start-up of the apparatus for preparing nitric acid, a gas mixture can preferably be conveyed through a bypass (4) around the absorption apparatus (7). The opening and/or closing of the bypass and the feed facility can preferably be regulated by means of a control device (3).

When shutting down the apparatus for preparing nitric acid, the combustion of NH₃ in the reactor is preferably firstly stopped, so that no further NOₓ nitrogen oxides (1) are formed. The NOₓ nitrogen oxides (1) still present in the apparatus downstream of the reactor are preferably cooled in the heat exchanger (2). A gas mixture is preferably also conveyed through the apparatus for preparing nitric acid by means of a compressor after the combustion of NH₃ has been stopped. As a result, the concentration of NOₓ nitrogen oxides in the feed means (5) drops, whereupon the feed means (5) are preferably closed by means of the closure device of the feed means (3′). This preferably interrupts the air stream through the absorption apparatus, as a result of which at least part of the NOₓ nitrogen oxides are blocked-in in the absorption apparatus. As an alternative, the discharge means (8) can also optionally be closed in order to prevent outflow of NOₓ nitrogen oxides from the absorption apparatus (7). The bypass (4) is preferably opened simultaneously by means of the closure device of the bypass (3″), so that the gas mixture which flows through the apparatus for preparing nitric acid preferably fully bypasses the absorption apparatus. Desorption of NOₓ nitrogen oxides (1) from the nitric acid which is present in the absorption apparatus (7) into the gas mixture which flows through the apparatus for preparing nitric acid is preferably prevented thereby.

As soon as the combustion of NH₃ in the reactor is stopped, further cooling in the heat exchanger (2) of the NOₓ nitrogen oxides (1) still present in the apparatus downstream of the reactor can be disadvantageous since cooling of the NOₓ nitrogen oxides (1) acts counter to very long operation of the residual gas purification plant (12); the heat present in the NO_{X} nitrogen oxides can instead keep the residual gas purification plant (12) at the required temperature for a certain time. For this reason, the feed means (5) are preferably closed after stopping of the combustion of NH₃ in the reactor and a gas mixture is preferably fed via the bypass (4) going around both the absorption apparatus (7) and the heat exchanger (2) to the residual gas purification plant (12) (not shown in FIG. 1). Here, the residual heat of the NOₓ nitrogen oxides is preferably exploited for catalytic decomposition and reduction within the residual gas purification plant (12).

When starting up the apparatus for preparing nitric acid, the residual gas purification plant (12) has usually not yet attained the temperature which is necessary for the catalytic reduction or decomposition of NOₓ nitrogen oxides (1). In this state, the feed means (5) are preferably closed and the bypass (4) is preferably open. Before ignition of the combustion of ammonia when starting up the apparatus for preparing nitric acid, the residual gas purification is preferably heated until it has attained a temperature which allows the introduction of ammonia into the residual gas purification. As soon as the residual gas purification plant has attained its operating temperature, the bypass (4) is preferably closed and the feed means (5) and discharge means (8) are preferably opened. The NOₓ nitrogen oxides leaving the absorption apparatus (7) can preferably be reduced in the heated residual gas purification. The combustion of ammonia is then preferably started. This can preferably prevent NOₓ nitrogen oxides (1) which have remained in the absorption apparatus (7) during shutdown of the apparatus for preparing nitric acid from being able to leave the absorption apparatus before the residual gas purification plant has attained the necessary operating temperature. In addition, desorption of NOₓ nitrogen oxides from nitric acid present in the absorption apparatus (7) is preferably prevented. Preference is given to closing the bypass (4) and opening the feed means (5) as soon as the residual gas purification plant (12) is taken into operation. NOₓ nitrogen oxides (1) which have remained in the absorption apparatus (7) can then preferably flow through the discharge means (8) to the residual gas purification plant (12) and be decomposed or reduced there.

### LIST OF REFERENCE NUMERALS

| | |
|---|---|
| 1 | NOₓ nitrogen oxides |
| 2 | heat exchanger |
| 3 | control device |
| 3′ | closure device for the feed means |
| 3″ | closure device for the bypass |
| 4 | bypass |
| 5 | feed means |
| 6 | bottom region |
| 7 | absorption apparatus |
| 8 | discharge means |
| 9 | further heat exchanger |
| 10 | ammonia |
| 11 | mixing device |
| 12 | residual gas purification plant |
| 13 | residual gas |

1.-15. (canceled)

16. An apparatus for preparing nitric acid from NOx nitrogen oxides, the apparatus comprising:
a reactor configured to produce NOx nitrogen oxides;
an absorption apparatus configured to absorb at least part of the NOx nitrogen oxides produced in an aqueous composition;
a residual gas purification plant configured to at least one of decompose or reduce unabsorbed NOx nitrogen oxides;
feed means configured to feed the NOx nitrogen oxides from the reactor to the absorption apparatus;
discharge means configured to discharge the unabsorbed NOx nitrogen oxides from the absorption apparatus to the residual gas purification plant; and
a bypass configured to transfer a gas mixture from the reactor to the residual gas purification plant, bypassing the absorption apparatus during at least one of startup or shutdown of the apparatus for preparing nitric acid.

17. The apparatus for preparing nitric acid of claim 16 further comprising a control device configured to at least one of
open and close the bypass;
open and close the feed means; or
open and close the discharge means.

18. The apparatus for preparing nitric acid of claim 17 wherein the control device is configured to open and close the discharge means.

19. The apparatus for preparing nitric acid of claim 16 wherein the bypass is configured to transfer the gas mixture from the reactor to the residual gas purification plant, bypassing the absorption apparatus and a heat exchanger.

20. The apparatus for preparing nitric acid of claim 16 wherein the absorption apparatus comprises sieve trays.

21. The apparatus for preparing nitric acid of claim 16 wherein the absorption apparatus comprises bubble cap trays.

22. A process for reducing a concentration of NOx nitrogen oxides in residual gas obtained during a startup or a shutdown of an apparatus for preparing nitric acid from NOx nitrogen oxides, the apparatus for preparing nitric acid comprising a reactor configured to produce NOx nitrogen oxides, an absorption apparatus configured to absorb at least part of the NOx nitrogen oxides produced in an aqueous composition, a residual gas purification plant configured to at least one of decompose or reduce unabsorbed NOx nitrogen oxides, feed means configured to feed the NOx nitrogen oxides from the reactor to the absorption apparatus, discharge means configured to discharge the unabsorbed NOx nitrogen oxides from the absorption apparatus to the residual gas purification plant, and a bypass configured to transfer a gas mixture from the reactor to the residual gas purification plant while bypassing the absorption apparatus during the startup or the shutdown of the apparatus for preparing nitric acid, the process comprising:
stopping feeding of the gas mixture from the reactor to the absorption apparatus; and
transferring the gas mixture from the reactor to the residual gas purification plant, bypassing the absorption apparatus.

23. The process of claim 22 wherein the transferring of the gas mixture from the reactor to the residual gas purification plant further comprises bypassing a heat exchanger.

24. The process of claim 22 further comprising stopping the discharge of the unabsorbed NOx nitrogen oxides from the absorption apparatus to the residual gas purification plant.

25. The process of claim 24 wherein at least one of the stopping feeding of the gas mixture, transferring the gas mixture, or stopping the discharge of the unabsorbed NOx nitrogen oxides is performed
after the residual gas purification plant is taken out of operation during the shutdown of the apparatus for preparing nitric acid, or
during the startup of the apparatus for preparing nitric acid before the residual gas purification plant is in operation.

26. The process of claim 22 wherein the bypassing of the absorption apparatus while transferring the gas mixture from the reactor to the residual gas purification plant is stopped as long as the residual gas purification plant is in operation during the shutdown of the apparatus for preparing nitric acid or as soon as the residual gas purification plant is put into operation during the startup of the apparatus for preparing nitric acid.

27. The process of claim 22 wherein at least a portion of the NOx nitrogen oxides that are present within the apparatus for preparing nitric acid are blocked-in in the absorption apparatus by the stopping of the feeding of the gas mixture from the reactor to the absorption apparatus.

28. The process of claim 27 wherein the blocking-in of the NOx nitrogen oxides in the absorption apparatus is also caused by stopping the discharge of the unabsorbed NOx nitrogen oxides from the absorption apparatus to the residual gas purification plant.

29. The process of claim 22 wherein the absorption apparatus comprises sieve trays that are filled with nitric acid when the apparatus for preparing nitric acid is started, wherein the filling with nitric acid is performed as soon as the residual gas purification plant is put into operation.

30. The process of claim 22 wherein the absorption apparatus comprises bubble cap trays that are pre-filled with nitric acid when the apparatus for preparing nitric acid is started.

31. The process of claim 22 comprising conveying at least a portion of nitric acid that condenses out in a heat exchanger into the absorption apparatus.
